(19) United States
(12) Patent Application Publication
(10) Pub. No.: US 2017/0028670 A1
(43) Pub. Date: Feb. 2, 2017

(54) COMPOSITE STRUCTURE

(71) Applicant: Airbus Operations Limited, Bristol (GB)

(72) Inventor: Jonathan PRICE, Bristol (GB)

(21) Appl. No.: 15/221,095

(22) Filed: Jul. 27, 2016

(30) Foreign Application Priority Data
Jul. 27, 2015 (GB) 1513213.7

(51) Int. Cl. B32B 3/26; B32B 5/26; B29C 70/54; B29C 70/70; B29C 70/34; B32B 7/12; B32B 7/08

(52) U.S. Cl. CPC B32B 3/266; B32B 7/12; B32B 5/26; B32B 7/08; B29C 70/70; B29C 70/342; B29C 70/545; B32B 2260/023; B32B 2260/046; B32B 2605/18; B29K 2105/0881

(57) ABSTRACT

A structure comprising a stack of composite plies of fiber-reinforced matrix material. The structure includes reinforcing inserts and holes. Each reinforcing insert is embedded in the stack and bonded to the stack, and each hole passes through a respective one of the reinforcing inserts. A support layer is joined to each reinforcing insert. The support layer is formed from a different material to the composite plies and impregnated with the same matrix material as the composite plies. The support layer carries the inserts during the assembly of the structure, and can assist in a process of infusing and/or curing the stack.

### RELATED APPLICATION

This application claims priority to Great Britain application GB 1513213.7 filed Jul. 27, 2015, and which is incorporated in its entirety.

### FIELD OF THE INVENTION

The present invention relates to a composite structure, and a method of manufacturing a composite structure.

### BACKGROUND OF THE INVENTION

Laminated fiber-reinforced composite structures, such as aircraft wing covers, are limited in their through-thickness capability to accommodate high load introduction. This limits the level of strain at which such structures can operate.

Traditionally such structures are mechanically fastened (for instance by bolts) to other work pieces, the bolts passing through machined holes in the structure. A traditional solution to the limited bolt-bearing capability of the structure is to locally increase its thickness at the hole locations. This can lead to an inefficient solution which adds weight and cost.

### SUMMARY OF THE INVENTION

A first aspect of an embodiment of the invention provides a structure comprising a stack of composite plies of fiber-reinforced matrix material. The structure comprises a plurality of reinforcing inserts and a plurality of holes, wherein each reinforcing insert is embedded in the stack and bonded to the stack and each hole passes through a respective one of the reinforcing inserts. A support layer is joined to each reinforcing insert. The support layer is formed from a different material to the composite plies and impregnated with the same matrix material as the composite plies. The support layer carries the inserts during the assembly of the structure, and can assist in a process of infusing and/or curing the stack.

The reinforcing inserts improve the fastener-bearing capability of the structure. As a result, local increases in thickness of the structure around the inserts can be avoided or at least minimised.

Typically the reinforcing inserts are co-bonded to the matrix material of the stack during a cure of the structure, rather than being secondary bonded to the stack by an adhesive which is different to the matrix material of the stack. In other words the reinforcing inserts are typically in direct contact with the matrix material of the stack.

The support layer may be at the top or bottom of the stack, but more typically it is embedded in the stack with first and second composite plies of the stack positioned on opposite sides of the porous support layer, and the first and second composite plies bonded to each reinforcing insert. Typically the support layer is located at a position of half thickness in the stack—in other word half way up the stack.

Typically the support layer is a metallic support layer.

The support layer may be a grid or mesh, a plate perforated with holes, or any other porous structure which can become impregnated with matrix material.

The inserts may pass through a full thickness of the stack, but more typically a pair of capping plies of fiber-reinforced matrix material are provided at opposite ends of the reinforcing inserts, wherein each reinforcing insert is bonded to the capping plies, and each hole passes through the pair of capping plies as well as through a respective one of the reinforcing inserts.

Typically each reinforcing insert has a side and a pair of end faces; at least two composite plies of the stack have internal edges which are bonded to the sides of the reinforcing inserts; the structure further comprises a pair of capping plies of fiber-reinforced matrix material which are bonded to the end faces of the reinforcing inserts; and each hole passes through the pair of capping plies.

The reinforcing inserts may be made of metal or any other suitable reinforcement material - for instance a polymer material such as Tufnol®.

The fiber-reinforced matrix material is reinforced with fibers which may be carbon, glass or any other suitable fiber reinforcement material. Typically the fiber reinforcement material is different to the material forming the reinforcing inserts.

Typically the matrix material is a thermosetting material such as epoxy resin or an ester-based system. Alternatively it may be a thermoplastic material.

Typically at least two composite plies of the stack have internal edges which are bonded to the reinforcing inserts. Most preferably at least four composite plies of the stack have internal edges which are bonded to the reinforcing inserts. The internal edges are typically cut edges.

A second aspect of an embodiment the invention provides a joint comprising a workpiece; and a structure according to the first aspect of the invention joined to the workpiece by fasteners such as bolts, each fastener having a shank which passes through a respective one of the holes.

A third aspect of an embodiment of the invention provides a method of manufacturing the structure of the first aspect of the invention, the method comprising: laying up a stack of composite plies of fiber-reinforced matrix material on a layup tool with a plurality of reinforcing inserts embedded in the stack, wherein the reinforcing inserts are carried by a porous support layer before they are embedded in the stack; heating and curing the matrix material so the reinforcing inserts become co-bonded to the stack and the porous support layer becomes impregnated with the matrix material; and after the matrix material has cured, forming a plurality of holes, each hole passing through a respective one of the reinforcing inserts.

A fourth aspect of an embodiment of the invention provides a method of manufacturing the structure of the first aspect of the invention, the method comprising: laying up a stack of dry fiber plies on a layup tool with a plurality of reinforcing inserts embedded in the stack, wherein the reinforcing inserts are carried by a porous support layer before they are embedded in the stack; infusing the stack of dry fiber plies with matrix material which flows into contact with the reinforcing inserts and impregnates the porous support layer; curing the matrix material so that the reinforcing inserts become co-bonded to the stack; and after the matrix material has cured, forming a plurality of holes, each hole passing through a respective one of the reinforcing inserts.

Forming the holes in the reinforcement inserts after the matrix material has cured ensures that matrix material does not flow into the holes. It also enables the holes to be formed in any capping plies at the same time.

Typically the holes are formed by the removal of material—for instance by a machining process such as drilling.

Typically the entire stack is cured at the same time as the reinforcing inserts become co-bonded to the matrix material. In other words, there is no need for two separate cure cycles—one to cure the stack and another to form the bond with the reinforcing inserts.

Typically the matrix material flows into intimate contact with the reinforcing inserts before it cures so that the reinforcing inserts become co-bonded to the matrix material.

Optionally the composite or dry fiber plies are pre-formed with holes to accommodate the reinforcing inserts before the reinforcement inserts are embedded in the stack. These holes may be pre-formed by cutting.

The reinforcement inserts may be embedded in the stack after some or all of the plies have been laid up onto the layup tool, or they may become embedded in the stack as the plies are laid up onto the layup tool.

The reinforcement inserts may be embedded in the stack by inserting them into pre-formed holes in the stack and/or by laying composite or dry fiber plies onto the layup tool so that the inserts are received in pre-formed holes in the plies as they are laid onto the layup tool.

The reinforcing inserts carried by the porous support layer may be embedded in the stack one-by-one, but more typically they are simultaneously embedded in the stack.

The porous support layer may be at a top or bottom of the stack of composite or dry fiber plies, but more typically the porous support layer is embedded in the stack with first and second plies of the stack positioned on opposite sides of the porous support layer, and the first and second plies become co-bonded to the reinforcing insert as the matrix material cures.

The reinforcing inserts may be joined to the porous support layer before the reinforcing inserts are embedded in the stack by welding or any other suitable method.

Typically the matrix material is a thermosetting material such as epoxy resin or an ester-based system which is cured by the action of heat. Alternatively it may be a thermoplastic material which is cured by allowing it to cool down and solidify.

### BRIEF DESCRIPTION OF THE DRAWINGS

Embodiments of the invention will now be described with reference to the accompanying drawings, in which:

FIG. 1 is a cross sectional view of a structure according to an embodiment of the invention;

FIGS. 2 to 4 show initial steps in a method of manufacturing the structure of FIG. 1;

FIG. 5 is a plan view of a support grid;

FIGS. 6 to 8 show the final steps of the method of manufacturing the structure of FIG. 1;

FIG. 9 is a plan view of the structure of FIG. 1;

FIG. 10 shows an alternative method of manufacturing a structure, using a dowel pin;

FIG. 11 shows part of a joint incorporating the structure of FIG. 1;

FIG. 12 is a plan view showing more of the joint of FIG. 11; and

FIG. 13 is a cross sectional view of a structure according to a further embodiment of the invention, with no capping plies.

### DETAILED DESCRIPTION OF EMBODIMENT(S) OF THE INVENTION

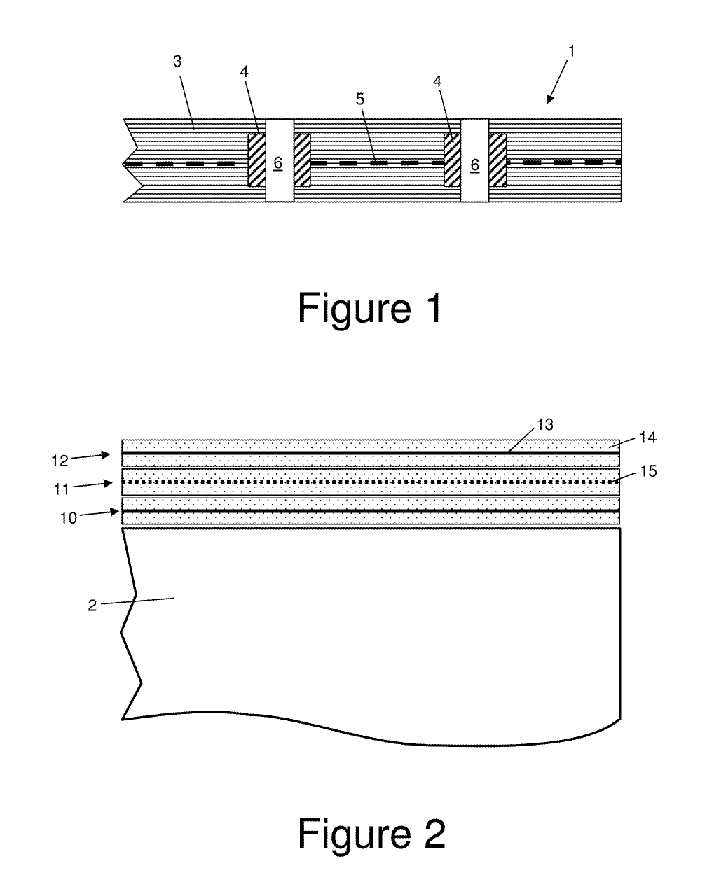

FIG. 1 shows a structure 1 comprising a stack 3 of composite plies of fiber-reinforced matrix material. Cylindrical reinforcing inserts 4 are embedded in the stack 3 and bonded to the stack 3. A hole 6 passes though each reinforcing insert 4.

FIG. 2 shows a first stage in a method of manufacturing the structure 1. Three capping plies 10-12 are first laid up on a layup tool 2. Each capping ply 10-12 is a so-called “pre-preg” consisting of a layer of reinforcement fibers pre-impregnated with epoxy resin matrix material. In this example each reinforcement layer is a layer of uni-directional carbon fibers, although alternatively the fibers may be woven or non-crimped. The carbon fibers in the upper capping ply 12 run in the plane of the cross-section of FIG. 2 and indicated at 13, and the epoxy resin matrix material of this upper capping ply 12 is indicated at 14. The carbon fibers in the capping ply 11, on the other hand, run transverse to the plane of the cross-section and are indicated at 15. The direction of the uni-directional fibers is selected according to the structural properties required. In the example of FIG. 2 the uni-directional fibers of the plies 10, 12 are running in the same direction, and the fibers of the capping ply 11 are running transverse to that direction. Further plies may be provided in which the fibers run at +/−45 degrees as is well known in the art. In this example, three capping plies 10-12 are shown but in general any number of capping plies may be laid up, including only a single capping ply.

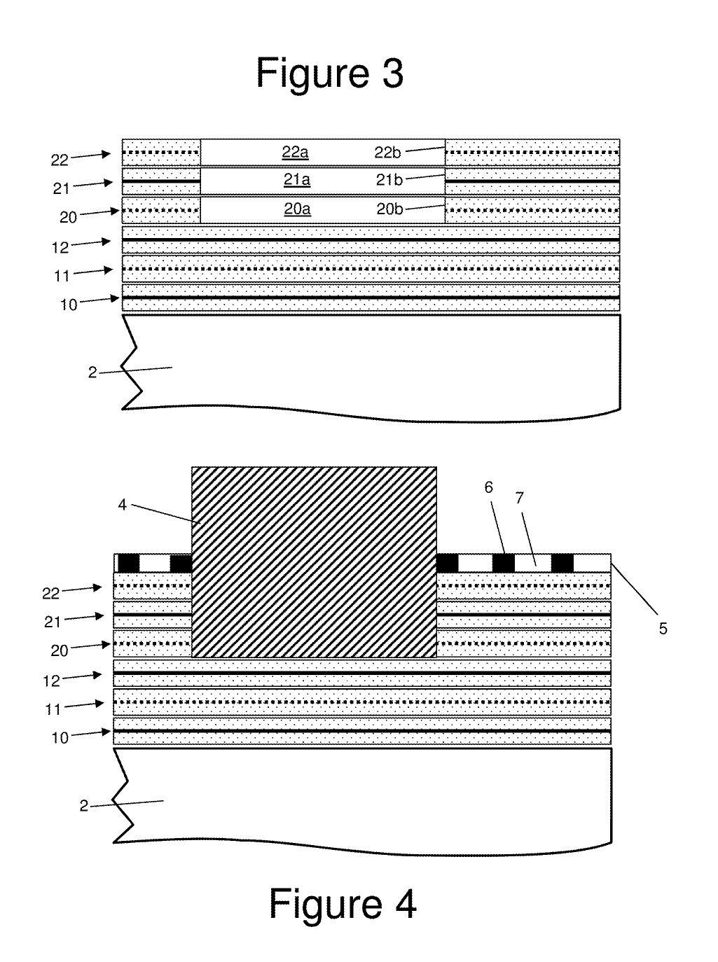

FIG. 3 shows the next stage in the method of manufacture. Three internal composite plies 20-22 are laid up one-by-one on top of the capping ply 12. A circular hole 20a-22a is pre-cut in each ply 20-22 with an ultrasonic knife or other ply cutting tool. Each ply 20-22 has a circular internal cut edge 20b-22b at the edge of the hole. The plies 20-22 are laid up with the holes 20a-22a aligned as shown in FIG. 3.

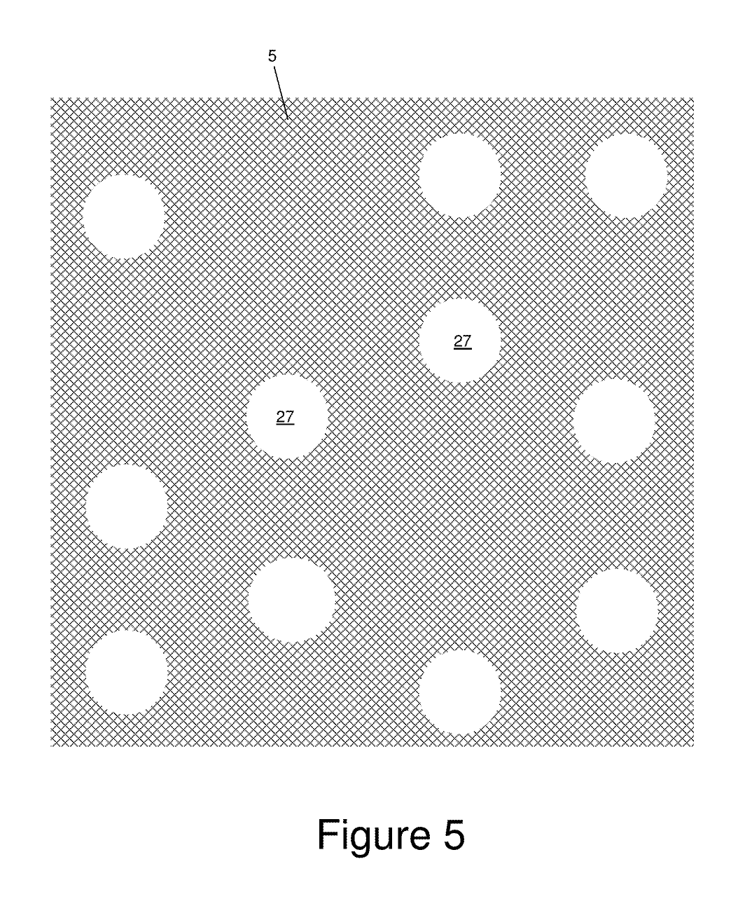

The next manufacturing stage is shown in FIG. 4. A porous metal support grid 5 shown in plan in FIG. 5 is cut with a plurality of holes 27 in desired locations. A cylindrical metal reinforcing insert 4 is then fitted into each hole 27 and welded to the grid 5. The support grid 5 is shown in cross section in FIG. 4, and comprises a network of metal struts 6 separated by pores 7. The size of the struts 6 and the pores 7 may vary from that shown. The support grid 5 supports the inserts 4 as each insert 4 is simultaneously fitted into a respective aligned set 20a to 22a of holes in the internal plies 20-22 as shown in FIG. 4. When the inserts 4 are fully inserted, the support grid 5 contacts the upper internal ply 22.

The next stage is shown in FIG. 6. A second set of three internal composite plies 30-32 are laid on top of the support grid 5. The plies 30-32 have pre-cut holes (like the holes 20a-22a in the first set) and the reinforcing inserts 4 are received in these holes as the plies 30-32 are laid up one-by-one. Three capping plies 40-42 are then laid on top of the reinforcing inserts.

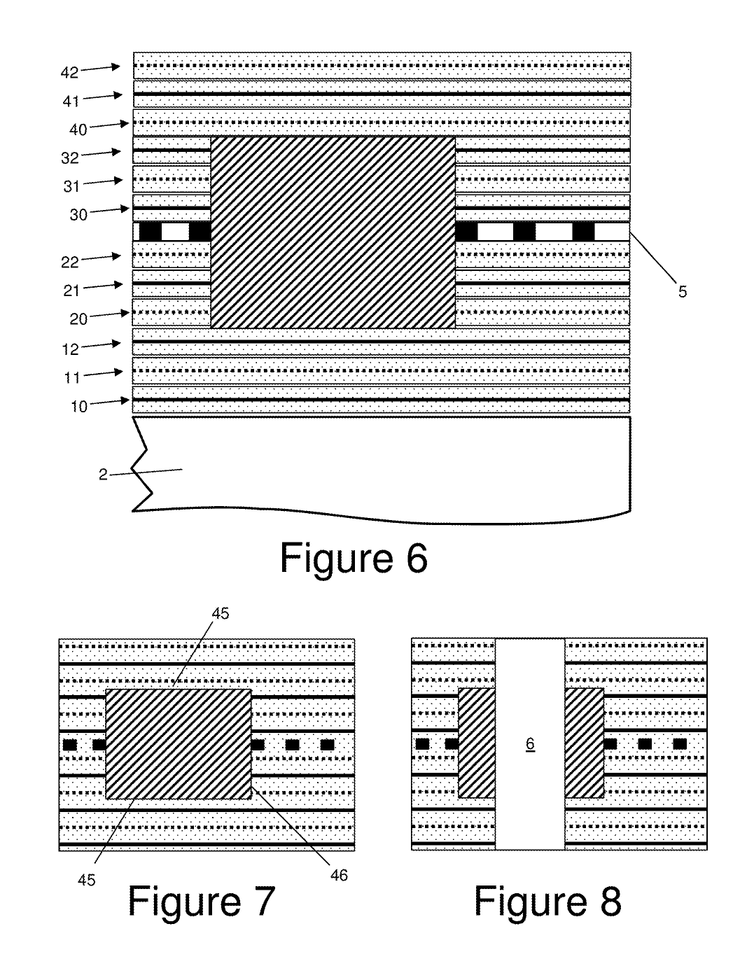

Next, a vacuum bag is laid over the stack and evacuated to compress the stack, which is then heated so that the thermosetting epoxy resin matrix material melts and then cures to provide the consolidated structure shown in FIG. 7. The melted matrix material coalesces between the plies and then bonds the plies together by co-curing. The heating of the matrix material also causes the matrix material to impregnate the pores 7 in the support grid 5 as shown in FIG. 7. The matrix material also flows into intimate contact with the reinforcing inserts 4, so that the capping plies 12, 40 become co-bonded to the end faces 45 of the reinforcing inserts and the circular internal cut edges of the internal plies 20-22, 30-32 become co-bonded to the cylindrical sides 46 of the reinforcing inserts as the matrix material cures.

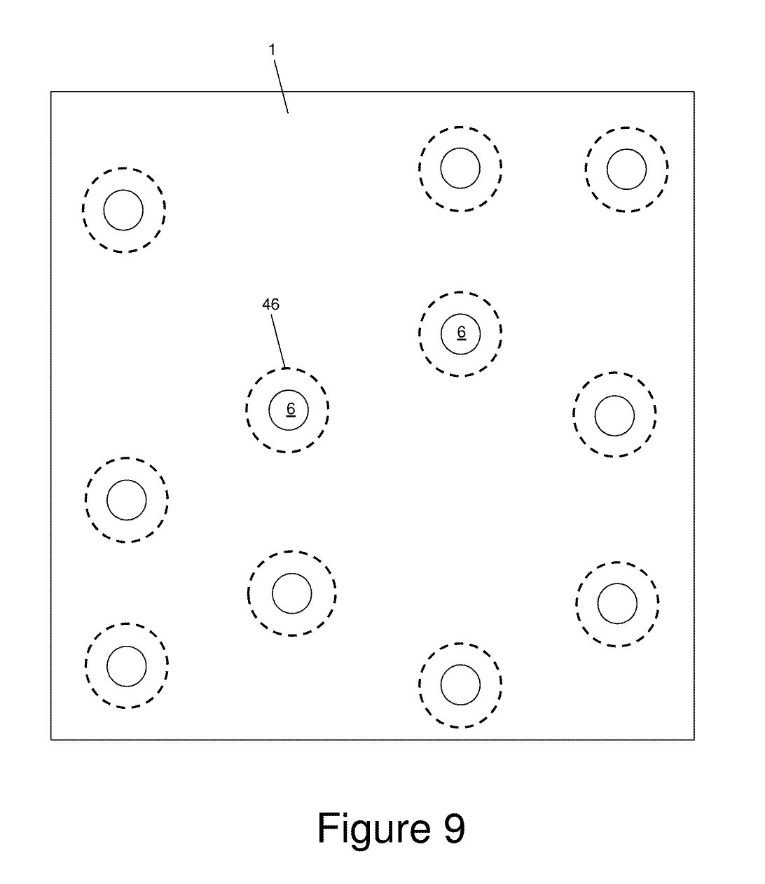

In a final manufacturing step shown in FIG. 8, holes 6 are drilled through the structure, each hole 6 passing through the upper capping plies 30-32, a respective one of the reinforcing inserts 4, and the lower capping plies 10-12. As shown in FIG. 9, the holes 6 are circular, and concentric with the cylindrical sides 46 of the embedded reinforcing inserts which are shown in dashed line FIG. 9.

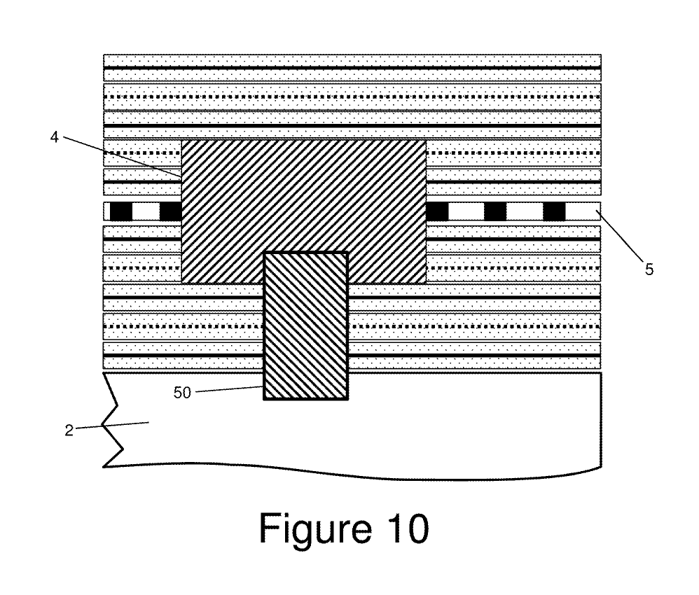

FIG. 10 shows a cross sectional view through an alternative structure which is similar to the structure of FIG. 1, except a cylindrical dowel pin 50 is provided for each insert. Dowel pins are inserted into suitably positioned cylindrical recesses in the upper surface of the layup tool 2. The lower capping plies are laid up onto the dowel pins (the capping plies being pre-formed with suitably positioned holes to accommodate the dowel pins) and each reinforcing insert 4 similarly has a downwardly facing recess which receives the upper end of a respective one of the cylindrical dowel pins as shown in FIG. 10. The dowel pins are left in-situ during the curing process and then drilled out when the holes 6 are drilled.

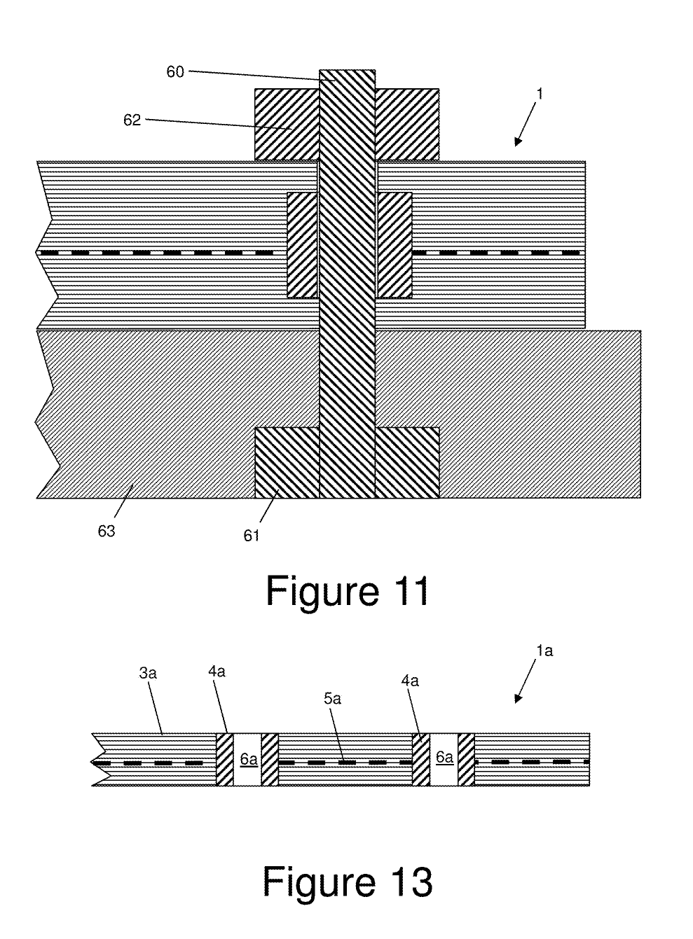

FIG. 11 shows part of a joint incorporating the structure of FIG. 1. The structure 1 is joined to a metal work piece 63 by a bolt having a shank 60 which passes through the hole 6 and through the work piece 63 as shown in FIG. 11. The fastener has a head 61 which is countersunk within the work piece and a tail fitted with a nut 62 as shown in FIG. 11. By way of example, the structure 1 may be an aircraft wing cover, and the work piece 63 may be a main landing gear structure or engine pylon structure.

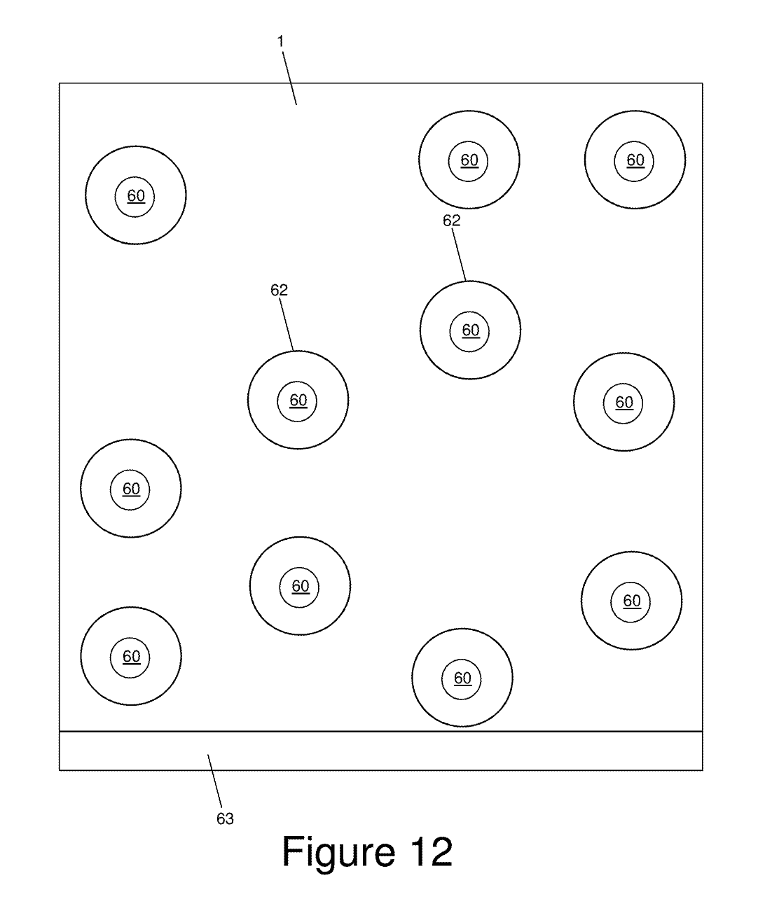

FIG. 11 is an enlarged view of the joint showing only a single fastener 60-62, whereas FIG. 12 is an expanded view showing the structure 1 joined to the workpiece 63 by a plurality of fasteners, each fastener having a shank 60 which passes through a respective one of the inserts.

FIG. 13 shows an alternative structure la which is similar to the structure 1 of FIG. 1, except that there are no capping plies. The features of the structure of FIG. 12 are otherwise identical and are labelled with the same reference numerals with the letter “a” added. Thus the structure of FIG. 12 will not be described in any further detail.

The method described above with reference to FIGS. 2-8 forms a structure 1 using pre-preg composite plies, but in an alternative method of manufacturing the structure of FIG. 1, a resin infusion method may be used. Rather than laying up pre-pregs onto the layup tool, a stack of dry fiber plies is laid up in a similar manner with embedded reinforcing inserts 4. After the stack has been assembled, it is infused with epoxy resin matrix material which flows into contact with the reinforcing inserts and impregnates the support grid 5. The porous support grid 5 assists the flow of the matrix material through the thickness of the stack during the infusion process. So when the resin infusion method is used, the grid 5 provides two distinct advantages: firstly it provides a convenient means of installing the reinforcing inserts accurately and in a single step, and secondly it provides an aid to the resin infusion process.

In the example given above, the holes 6 are clearance drilled but in an alternative embodiment the holes 6 may be formed with a thread to receive an externally threaded fastener shank.

Although the joint of FIGS. 11 and 12 joins a composite structure 1 to a metal work piece, the joint may be formed with any other work piece, including a similar composite structure with reinforcing metal inserts.

Although the invention has been described above with reference to one or more preferred embodiments, it will be appreciated that various changes or modifications may be made without departing from the scope of the invention as defined in the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. A structure comprising:
a stack of composite plies of fiber-reinforced matrix material;
a plurality of reinforcing inserts, wherein each reinforcing insert is embedded in the stack and bonded to the stack;
a plurality of holes, wherein each hole passes through a respective one of the reinforcing inserts; and
a support layer which is joined to each reinforcing insert, wherein the support layer is formed from a different material to the composite plies and impregnated with the same matrix material as the composite plies.

2. The structure of claim 1, wherein the support layer is embedded in the stack with first and second composite plies of the stack positioned on opposite sides of the support layer, and the first and second composite plies are bonded to each reinforcing insert.

3. The structure of claim 1, wherein the support layer is a metallic support layer.

4. The structure of claim 1, further comprising a pair of capping plies of fiber-reinforced matrix material at opposite ends of the reinforcing inserts, wherein each reinforcing insert is bonded to the capping plies, and each hole passes through the pair of capping plies.

5. The structure of claim 1, wherein each reinforcing insert is a metallic reinforcing insert.

6. The structure of claim 1, wherein at least two composite plies of the stack have internal edges which are bonded to the reinforcing inserts.

7. The structure claim 1, wherein each reinforcing insert has a side and a pair of end faces; at least two composite plies of the stack have internal edges which are bonded to the sides of the reinforcing inserts; and the structure further comprises:
a pair of capping plies of fiber-reinforced matrix material which are bonded to the end faces of the reinforcing inserts; and each hole passes through the pair of capping plies.

8. The structure of claim 1, wherein the support layer is a grid, a mesh, or a perforated plate.

9. A joint comprising a workpiece and a structure according to claim 1 joined to the workpiece by a plurality of fasteners, wherein each of the fasteners has a shank which passes through a respective one of the holes.

10. A method of manufacturing the structure of claim 1, the method comprising:
laying up a stack of composite plies of fiber-reinforced matrix material on a layup tool with a plurality of reinforcing inserts embedded in the stack, wherein the reinforcing inserts are carried by a porous support layer before they are embedded in the stack;
heating and curing the matrix material so the reinforcing inserts become co-bonded to the stack and the porous support layer becomes impregnated with the matrix material; and
after the matrix material has cured, forming a plurality of holes, each hole passing through a respective one of the reinforcing inserts.

11. A method of manufacturing the structure of claim 1, the method comprising:
laying up a stack of dry fiber plies on a layup tool with a plurality of reinforcing inserts embedded in the stack, wherein the reinforcing inserts are carried by a porous support layer before they are embedded in the stack;
infusing the stack of dry fiber plies with matrix material which flows into contact with the reinforcing inserts and impregnates the porous support layer;
curing the matrix material so that the reinforcing inserts become co-bonded to the stack; and
after the matrix material has cured, forming a plurality of holes, each hole passing through a respective one of the reinforcing inserts.

12. The method of claim 10 wherein the porous support layer is embedded in the stack with first and second plies of the stack positioned on opposite sides of the porous support layer, and the first and second plies become co-bonded to the reinforcing inserts as the matrix material cures.

13. The method of claim 11 wherein the porous support layer is embedded in the stack with first and second plies of the stack positioned on opposite sides of the porous support layer, and the first and second plies become co-bonded to the reinforcing inserts as the matrix material cures.

14. The method of claim 10 wherein the reinforcing inserts carried by the porous support layer are simultaneously embedded in the stack.

15. The method of claim 11 wherein the reinforcing inserts carried by the porous support layer are simultaneously embedded in the stack.

16. The method of claim 10 further comprising joining the reinforcing inserts to the porous support layer before the reinforcing inserts are embedded in the stack.

17. The method of claim 11 further comprising joining the reinforcing inserts to the porous support layer before the reinforcing inserts are embedded in the stack.

18. The method of claim 16 wherein the reinforcing inserts are joined to the porous support layer by welding.

19. The method of claim 17 wherein the reinforcing inserts are joined to the porous support layer by welding.

20. A method of manufacturing an aircraft structure comprising:
stacking dry fiber plies on a layup tool to form a stack;
embedding reinforcing inserts in the stack during the stacking, wherein the reinforcing inserts are carried by a porous support layer before being embedded in the stack;
infusing the stack with matrix material which flows into contact with the reinforcing inserts and impregnates the porous support layer;
after infusing the stack, curing the matrix material to bond the reinforcing inserts to the stack; and
after curing the matrix material, forming holes in the stack such that hole passing through a respective one of the reinforcing inserts.

21. The method of claim 20 further comprising joining a support layer to each reinforcing insert, wherein the support layer is formed from a material different than the composite plies and the support layer is infused with the matrix material.
